(19) United States
(12) Patent Application Publication
(10) Pub. No.: US 2003/0131114 A1
(43) Pub. Date: Jul. 10, 2003

(54) Portable electronic authenticator cryptographic module

(76) Inventors: Edward M. Scheidt, McLean, VA (US); C. Jay Wack, Clarksburg, MD (US); Wai Lin Tsang, Falls Church, VA (US)

Correspondence Address: IP STRATEGIES, P.C., Suite 301, 806 7th Street N.W., Washington, DC, 20001, US

(21) Appl. No.: 10/271,341

(22) Filed: Oct. 15, 2002

Related U.S. Application Data
(60) Provisional application No. 60/328,939, filed on Oct. 12, 2001.

(51) Int. Cl. G06F 15/16

(52) U.S. Cl. 709/229; 709/203

(57) ABSTRACT

A module includes a processor, a memory, a communication interface to provide a communication channel between the module and a computer, and a bus that communicatively connects the processor, memory, and communication interface. The memory can include an internal routine that sends a data instance to the computer via the communication channel. The data instance can be used for user authentication and/or user authorization. The data instance can be generated, or referenced from the memory, by the module. The communication channel can be hard-wired or wireless.

### CROSS-REFERENCE TO RELATED APPLICATIONS

This disclosure claims the priority benefit of, and incorporates by reference in its entirety, U.S. provisional patent application Ser. No. 60/328,939, filed on Oct. 12, 2001. Additionally, this disclosure is related to, and incorporates by reference the following co-pending U.S. patent applications in their entireties: U.S. patent application Ser. No. 09/023,672, entitled “Cryptographic Key Split Combiner,” filed on Feb. 13, 1998 by SCHEIDT et al.; Ser. No. 09/874,364, entitled “Cryptographic Key Split Combiner,” filed on Jun. 6, 2001 by SCHEIDT et al.; Ser. No. 09/917,795, entitled “Cryptographic Key Split Combiner,” filed on Jul. 31, 2001 by SCHEIDT et al.; Ser. No. 09/917,794, entitled “Cryptographic Key Split Combiner,” filed on Jul. 31, 2001 by SCHEIDT et al.; Ser. No. 09/917,802, entitled “Cryptographic Key Split Combiner,” filed on Jul. 31, 2001 by SCHEIDT et al.; Ser. No. 09/917,807, entitled “Cryptographic Key Split Combiner,” filed on Jul. 31, 2001 by SCHEIDT et al.; Ser. No. 10/147,433, entitled “Cryptographic Key Split Binding Process and Apparatus,” filed on May 16, 2002 by SCHEIDT et al.; Ser. No. 09/205,221, entitled “Access Control and Authorization System,” filed on Dec. 4, 1998 by SCHEIDT et al.; Ser. No. 09/388,195, entitled “Encryption Process Including a Biometric Input,” filed on Sep. 1, 1999 by SCHEIDT; Ser. No. 09/418,806, entitled “Cryptographic Information and Flow Control,” filed on Oct. 15, 1999 by WACK et al.; Ser. No. 09/936,315, entitled “Voice and Data Encryption Method Using a Cryptographic Key Split Combiner,” filed on Sep. 10, 2001 by SCHEIDT; Ser. NO. 10/060,039, entitled “Multiple Factor-Based User Identification and Authentication,” filed on Jan. 30, 2002 by SCHEIDT et al.; and Ser. No. 10/060,011, entitled “Multiple Level Access System,” filed on Jan. 30, 2002 by SCHEIDT et al.

### FIELD OF THE INVENTION

The present invention relates to computer security and user authentication, and more particularly, to electronic modules used to provide user authentication and user authorization in conjunction with a computer.

### BACKGROUND OF THE INVENTION

Electronic communications are becoming increasingly popular as an efficient and convenient manner of transferring information and communicating between parties or entities. Computer security needs extend to electronic banking, electronic mail, and computer workstation access, as well as myriad other forms of computer-based conduct. From Internet transactions to mobile telephone communications, the frequency and importance of electronic communications have grown exponentially in recent years. As the importance of electronic communications has grown, computer security has become equally important to safe guard sensitive data and to limit access to computer resources to authorized individuals.

With the increased importance of computer security, password-based authentication routines are being replaced with, or at least bolstered by, more sophisticated security mechanisms, such as smart card- and biometric-based identification/authentication protocols. While security-based measures continue to grow in complexity and strength, the remains a need for a scalable mechanism for providing computer security. Brief Summary of the Invention The present invention provides user authentication and/or authorization through the use of an electronic module, which communicates with a computer via a communication channel. The module provides, to the computer, a data instance that is used for the authentication and/or authorization of the user. Thus, possession of the module by a user provides increased security. The data instance can include any type of data that can be used to authenticate and/or authorize a user, and is, therefore, broadly defined. Additionally, the computer may be communicatively connected to a server or base station; and therefore, authentication and/or authorization can extend beyond the computer to additional resources available by or through the server or base station.

The computer can be any of a broad range of devices, which can include, for example and not in limitation, a PDA (“personal digital assistant”), a pager, a handheld computer, a workstation, a mobile telephone, etc. The present invention, therefore, is intended to provide increased security to any computer-based device that can be adapted to communicate with the module.

The communication channel between the module and the computer can be any type of communication channel, whether hard-wired or wireless. Further, wireless communication channels can provide enhanced convenience, and additionally, advantageous features. For example, a communication channel operating at a frequency of about 60 GHz can allow the leverage of the propagation- and/or coverage-limited properties thereof.

The module can be portable, such that a user can move the module from place to place. Additionally, the module can be, or integrated with, a wearable item, such as a watch, a clothing patch, a ring, a broach, or the like, for example and not in limitation.

Therefore, the present invention can be embodied in a module, which can be utilized for user authentication and/or user authorization; a method of authenticating and/or authorizing a user; a system having a module, a computer, and optionally, a server or base station; and a storage medium having computer instructions for carrying out user authentication and/or authorization.

In an exemplary embodiment, the present invention includes an electronic module, which can be used for user authentication and/or user authorization. In an exemplary aspect of the invention, the module includes at least one processor, at least one memory, and at least one bus communicatively connecting the processor, memory, and the wireless communication interface. The wireless communication interface provides a communication channel between the module and a computer, and operates at a frequency of about 60 GHz. The memory includes at least one internal routine that is adapted to send a data instance to the computer via the communication channel. The data instance can be used for user authentication and/or user authorization. The data instance can be any type of data adaptable for use with a user authentication and/or authorization schema. For example, and not in limitation, a data instance can include any of a cryptographic key, a key component, a seed value, an encrypted value, a decrypted value, a cryptographic function parameter, a password, a user identifier, a serial number, and a user credential. The at least one internal routine can be further adapted to generate the data instance. Alternatively, the memory can include the data instance, and the at least one internal routine can be further adapted to reference the data instance from the memory.

In another exemplary embodiment, the present invention includes an electronic module, which can be used for user authentication and/or user authorization. In an exemplary aspect of the invention, a module includes at least one processor, at least one memory, and at least one bus communicatively connecting the processor, memory, and the wireless communication interface. The wireless communication interface provides a communication channel between the module and a computer, and operates at a frequency of about 60 GHz. The memory includes at least one cryptographic routine that is adapted to generate a first data instance and to send the first data instance to the computer via the wireless communication channel. The data instance can be used for user authentication and/or user authorization. The data instance can be any form of data adaptable for use with a user authentication and/or authorization schema. For example, and not in limitation, a data instance can include any of a cryptographic key, a key component, a seed value, an encrypted value, a decrypted value, a cryptographic function parameter, a password, a user identifier, a serial number, and a user credential. In another exemplary aspect, the at least one cryptographic routine can be further adapted to receive a second data instance from the computer via the wireless communication channel, and to generate the first data instance based at least in part on the second data instance. In another exemplary aspect of the invention, the at least one cryptographic routine can include a cryptographic key component (or key split) combiner.

In a further exemplary embodiment, the present includes a method that operates in a system, which includes a computer having a first wireless communication interface, and a module having a second wireless communication interface. The method includes establishing, between the first and second wireless communication interfaces, a communication channel that operates at a frequency of about 60 GHz; and sending, by the module, a first data instance to the computer via the communication channel; where the first data instance includes at least one of user authentication data and user authorization data. Additionally, the method can further include receiving, by the module, a second data instance from the computer via the communication channel; and generating, by the module, the first data instance based at least in part on the second data instance. Alternatively, the method can further include referencing, by the module, the first data instance from at least one memory. For example, and not in limitation, the first and/or second data instance can be any one or more of a cryptographic key, a key component, a seed value, an encrypted value, a decrypted value, a cryptographic function parameter, a password, a user identifier, a serial number, and a user credential. In yet another exemplary aspect, the first data instance can be generated via at least one cryptographic routine, which includes at least a portion of a cryptographic algorithm or protocol.

In yet a further exemplary embodiment, the present invention includes a system, which includes a module having a first wireless communication interface; a computer having a second wireless communication interface; and a first communication channel, between the first and second wireless communication interfaces, that operates at a frequency of about 60 GHz. The module can be adapted to send a data instance to the computer over the first communication channel, and the data instance can be used to authenticate a user. The system can further include a server communicatively connected to the computer via a second communication channel, where the server is adapted to provide the user with access to a resource if the user is authenticated and/or authorized based at least in part on the data instance.

In any of the embodiments above, an alternative frequency or a hard-wired connection (and appropriate interface/s) can be utilized, to any extent recognized as being advantageous by those of skill in the art.

### BRIEF DESCRIPTION OF THE DRAWINGS

The present invention is illustrated by way of example and not limitation in the figures of the accompanying drawings in which like references indicate similar elements, and in which:

FIG. 1 illustrates an exemplary embodiment of a module having at least one processor, at least one memory, and a communication interface, communicatively connected by at least one bus.

FIG. 2 illustrates an exemplary embodiment of a system including a computer having a first communication interface, a module having a second communication interface, and a communication channel between the first and second communication interfaces.

FIG. 3 illustrates another exemplary embodiment of a system including a computer, a module, and a server/base station.

FIG. 4 illustrates an exemplary aspect of the invention, in which a cryptographic key component binder binds together a plurality of key components to provide a cryptographic key.

### DETAILED DESCRIPTION OF THE INVENTION

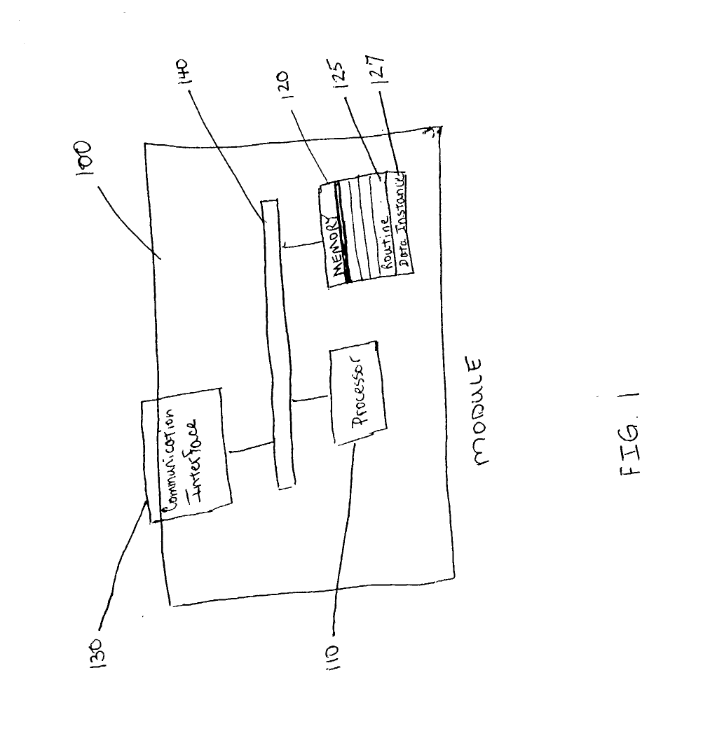

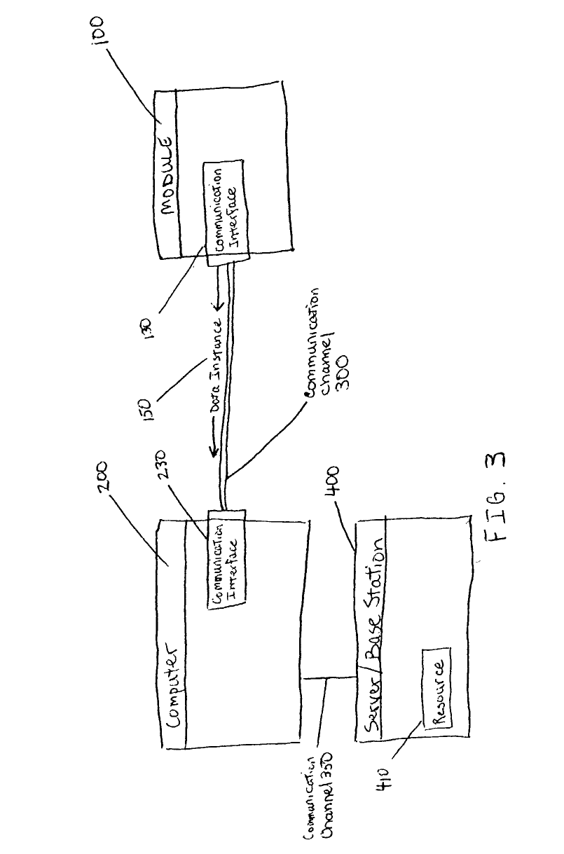

As illustrated in FIG. 1, the present invention provides user authentication and/or authorization through the use of an electronic module 100, which communicates with a computer 200 via a communication channel 300. The module 100 provides, to the computer 200, a data instance 150 that is used for the authentication and/or authorization of the user. Thus, possession of the module 100 by a user provides capability for improved security. The data instance 150 can include any type of data that can be used to authenticate and/or authorize a user, and is, therefore, broadly defined. Additionally, as shown in FIG. 3, the computer 200 can be communicatively connected to a server or base station 400; and therefore, authentication and/or authorization can extend beyond the computer to at least one additional resource 410 available by or through the server or base station.

The computer 200 can be any of a broad range of devices, which can include, for example and not in limitation, a PDA (“personal digital assistant”), a pager, a handheld computer, a workstation, a mobile telephone, and the like. The present invention, therefore, is intended to provide increased security to any computer-based device that can be adapted to communicate with the module 100.

The communication channel 300 between the module 100 and the computer 200 can be any type of communication channel, whether hard-wired or wireless. Further, wireless communication channels can provide enhanced convenience, and additionally, advantageous features. For example, a communication channel operating at a frequency of about 60 GHz can allow the leverage of the propagation- and/or coverage-limited properties thereof. The 60 GHz band (roughly between 59 and 64 GHz) is currently unlicensed for wireless communication applications. One reason that this band could be seen as undesirable in such applications is that it has the property of being the atmospheric oxygen absorption band. Thus, in an outdoor environment, signals are strongly attenuated, to the extent of roughly 15 dB/km in addition to the free space loss. In indoor applications, 60 GHz signals are also severely attenuated by inner walls and human bodies. Use of a cryptographic module communicating under such restraints might at first seem to be undesirable. However, limiting the range and angular position for which communication is reliable increases the likelihood that such communication is deliberate, while providing high data throughput.

The module 100 can be portable, such that a user can move the module from place to place as desired to utilize the security features at different locations. Additionally, the module can be, or integrated with, a wearable item, such as a watch, a clothing patch, a ring, a broach, or the like, for example and not in limitation.

Therefore, the present invention can be embodied in a module, which can be utilized for user authentication and/or user authorization; a method of authenticating and/or authorizing a user; a system having a module, a computer, and optionally, a server or base station; and a storage medium having computer instructions for carrying out user authentication and/or authorization.

Reference is now made to FIGS. 1-3. As illustrated in FIG. 1, in an exemplary embodiment, the present invention includes an electronic module 100, which can be used for user authentication and/or user authorization. In an exemplary aspect of the invention, the module 100 includes at least one processor 110, at least one memory 120, and at least one bus 140 communicatively connecting the processor 110, memory 120, and the wireless communication interface 130. The module's communication interface 130 provides a communication channel 300 between the module 100 and a computer 200, and operates at a frequency of about 60 GHz. The at least one memory 120 includes at least one routine 125 that is adapted to send a data instance 150 to the computer 200 via the communication channel 300. The data instance 150 can be used for user authentication and/or user authorization. The data instance 150 can be any type of data adaptable for use with a user authentication and/or authorization schema. For example, and not in limitation, a data instance 150 can include any of a cryptographic key, a key component, a seed value, an encrypted value, a decrypted value, a cryptographic function parameter, a password, a user identifier, a serial number, and a user credential. The at least one routine 125 can be further adapted to generate the data instance 150. Alternatively, the at least memory 120 can include the data instance 150, and the at least one routine 125 can be further adapted to reference the data instance 150 from the memory 120.

In an exemplary aspect of the invention, a credential can include any type of authorization data. Therefore, a particular user's credentials can define that user's authorization (or access) permissions. For example, and not in limitation, a credential can include one or more of a password, a pass-phrase, an access key, a cryptographic key, or the like. In another exemplary aspect of the invention, a credential can comprise at least one of a public key (write access) and a private key (read access). In yet another exemplary aspect of the invention, a credential-based cryptographic scheme can provide multiple levels of read and write access permissions through multiple asymmetric key pairs. Accordingly, a particular user can be provided with multiple permissions having varying levels of access permissions.

Reference is again made to FIGS. 1-3. In another exemplary embodiment, the present invention includes an electronic module 100, which can be used for user authentication and/or user authorization. In an exemplary aspect of the invention, a module 100 includes at least one processor 110, at least one memory 120, and at least one bus 140 communicatively connecting the processor, memory, and the wireless communication interface. The module's communication interface 130 provides a communication channel 300 between the module 100 and a computer 200, and operates at a frequency of about 60 GHz. The at least one memory 120 includes at least one cryptographic routine 125 that is adapted to generate a first data instance 150 and to send the first data instance 150 to the computer 200 via the communication channel 300. The data instance 150 can be used for user authentication and/or user authorization. The data instance 150 can be any form of data adaptable for use with a user authentication and/or authorization schema. For example, and not in limitation, a data instance 150 can include any of a cryptographic key, a key component, a seed value, an encrypted value, a decrypted value, a cryptographic function parameter, a password, a user identifier, a serial number, and a user credential. In another exemplary aspect, the at least one cryptographic routine 125 can be further adapted to receive a second data instance (not shown) from the computer 200 via the communication channel 300, and to generate the first data instance 150 based at least in part on the second data instance.

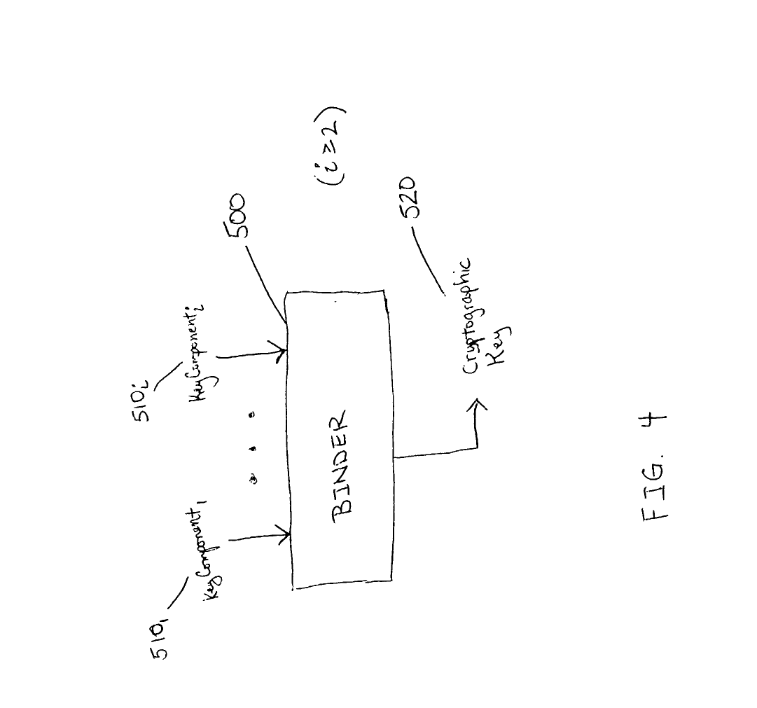

In another exemplary aspect of the invention, the at least one routine can include a cryptographic key component (or key split) binder. As illustrated in FIG. 4, a cryptographic key component binder 500 binds together a plurality of key components 510ᵢ to produce a cryptographic key 520. Binding, according to the present invention includes any manner of combining the plurality of data instances to form a cryptographic key 520, and includes one-way and two-way mathematical functions, as well as bitwise operations, for example and not in limitation.

In a further exemplary embodiment, the present includes a method that operates in a system, which includes a computer having a first wireless communication interface, and a module having a second wireless communication interface. The method includes establishing, between the first and second wireless communication interfaces, a communication channel that operates at a frequency of about 60 GHz, and sending, by the module, a first data instance to the computer via the communication channel, where the first data instance includes at least one of user authentication data and user authorization data. Additionally, the method can further include receiving, by the module, a second data instance from the computer via the communication channel; and generating, by the module, the first data instance based at least in part on the second data instance. Alternatively, the method can further include referencing, by the module, the first data instance from at least one memory. For example, and not in limitation, the first and/or second data instance can be any one or more of a cryptographic key, a key component, a seed value, an encrypted value, a decrypted value, a cryptographic function parameter, a password, a user identifier, a serial number, and a user credential. In yet another exemplary aspect, the first data instance can be generated via at least one cryptographic routine, which includes at least a portion of a cryptographic algorithm or protocol.

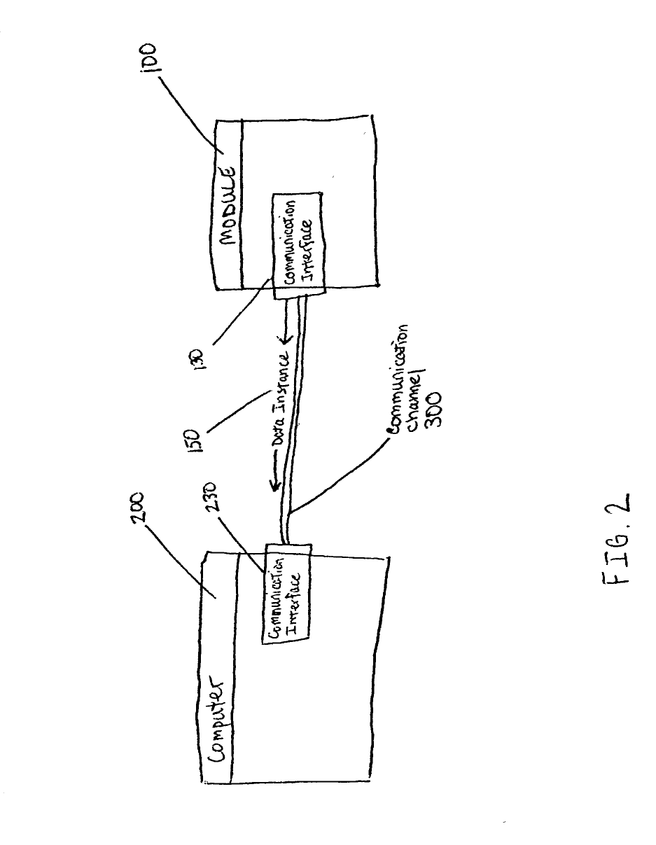

Referring now to FIGS. 2 and 3, in yet a further exemplary embodiment, the present invention includes a system, which includes a module 100 having a first communication interface 130, a computer 200 having a second communication interface 230, and a first communication channel 300, between the first and second wireless communication interfaces. The communication channel 300 can be hard-wired or wireless. Where wireless, the communication channel 300 can operate at a frequency of about 60 GHz. The module 100 can be adapted to send a data instance 150 to the computer 200 over the first communication channel 300, and the data instance 150 can be used to authenticate a user and/or authorize the user for access to a resource, which can reside on the computer 200, a server/base station 400, the module 100, or on another device or computer (not shown) communicatively connected therewith. As shown in FIG. 3, the system can further include a server/base station 400 communicatively connected to the computer 200 via a second communication channel 350, where the server/base station 400 is adapted to provide the user with access to a resource 410 if the user is authenticated and/or authorized based at least in part on the data instance 150.

It should be noted that in any of the embodiments above, any wireless or hardwired communication channel (and appropriate interface/s) can be employed to any extent that is feasible, as known to those of skill in the art.

In the foregoing specification, the invention has been described with reference to specific embodiments thereof. It will, however, be evident that various modifications and/or changes may be made thereto without departing from the broader spirit and scope of the invention. Accordingly, the specification and drawings are to be regarded in an illustrative and enabling, rather than a restrictive, sense.

We claim:

1. A module, comprising:
at least one processor;
at least one memory;
a wireless communication interface adapted to provide a communication channel between said module and a computer, and to operate at a frequency of about 60 GHz; and
at least one bus communicatively connecting said processor, said at least one memory, and said wireless communication interface;
wherein said at least one memory includes at least one internal routine adapted to send a data instance to the computer via the communication channel, and the data instance includes at least one of user authentication data and user authorization data.

2. The module of claim 1, wherein the data instance is one of a cryptographic key, a key component, a seed value, an encrypted value, a decrypted value, a cryptographic function parameter, a password, a user identifier, a serial number, and a user credential.

3. The module of claim 1, wherein the at least one internal routine is further adapted to generate the data instance.

4. The module of claim 1, wherein the at least one memory further includes the data instance, and the at least one internal routine is further adapted to reference the data instance from the at least one memory.

5. A module, comprising:
at least one processor;
at least one memory;
a wireless communication interface adapted to provide a communication channel between said module and a computer, and to operate at a frequency of about 60 GHz; and
at least one bus communicatively connecting said processor, said at least one memory, and said wireless communication interface;
wherein said at least one memory includes at least one cryptographic routine adapted to generate a first data instance and to send the first data instance to the computer via said wireless communication interface.

6. The module of claim 5, wherein the first data instance is one of a cryptographic key, a key component, a seed value, an encrypted value, a decrypted value, a cryptographic function parameter, a password, a user identifier, a serial number, and a user credential.

7. The module of claim 5, wherein the at least one cryptographic routine is further adapted to receive a second data instance from the computer via the wireless communication channel, and to generate the first data instance based at least in part on the second data instance.

8. The module of claim 5, wherein the at least one cryptographic routine includes a cryptographic key component combiner.

9. In a system comprising a computer having a first wireless communication interface, and a module having a second wireless communication interface, a method, comprising:
establishing, between the first and second wireless communication interfaces, a communication channel that operates at a frequency of about 60 GHz; and
sending, by the module, a first data instance to the computer via the communication channel;
wherein the first data instance includes at least one of user authentication data and user authorization data.

10. The method of claim 9, wherein the first data instance includes at least one of a cryptographic key, a key component, a seed value, an encrypted value, a decrypted value, a cryptographic function parameter, a password, a user identifier, a serial number, and a user credential.

11. The method of claim 9, further comprising
receiving, by the module, a second data instance from the computer via the communication channel; and
generating, by the module, the first data instance based at least in part on the second data instance.

12. The method of claim 9, further comprising referencing, by the module, the first data instance from at least one memory.

13. A system, comprising:
a module having a first wireless communication interface;
a computer having a second wireless communication interface; and
a first communication channel, between the first and second wireless communication interfaces, that operates at a frequency of about 60 GHz;
wherein said module is adapted to send a data instance to said computer over said first communication channel, and the data instance includes at least one of user authentication data and user authorization data.

14. The system of claim 13, further comprising:
a server communicatively connected to the computer via a second communication channel;
wherein said server is adapted to provide the user with access to a resource if the user is authenticated based at least in part on the data instance.
